(19) United States
(12) Patent Application Publication
(10) Pub. No.: US 2026/0322806 A1
(43) Pub. Date: Oct. 15, 2026

(54) SYSTEMS AND METHODS FOR AUTOMATICALLY IDENTIFYING AI-GENERATED AUDIO AND VISUAL MEDIA

(71) Applicant: BANK OF AMERICA CORPORATION, Charlotte, NC (US)

(72) Inventors: Nevetha Jeyarajaboopathy, Nagercoil (IN); Rama Venkata Kavali, Frisco, TX (US); Abhinav Dwivedi, Gandhinagar (IN); Venugopala Rao Randhi, Hyderabad (IN)

(73) Assignee: BANK OF AMERICA CORPORATION, Charlotte, NC (US)

(21) Appl. No.: 19/174,808

(22) Filed: Apr. 9, 2025

(51) Int. Cl. H04L 9/40; G06V 20/00; G06V 20/40; G10L 17/02; G10L 17/10; G10L 17/24; G10L 17/26; G10L 25/57

(52) U.S. Cl. CPC H04L 63/0861; G06V 20/40; G06V 20/95; G10L 17/02; G10L 17/10; G10L 17/24; G10L 17/26; G10L 25/57

(57) ABSTRACT

Systems, computer program products, and methods are described herein for automatically identifying AI-generated audio and visual media. The present disclosure is configured to receive a multimedia input from a user device; receive a key phrase from the user device; identify a user account based on the key phrase; extract and parse each frame from the multimedia input, wherein each frame is parsed for sound data; apply a word dictionary to at least one of the key phrase or each frame of the sound data, wherein the word dictionary is specific to the user account, and wherein the word dictionary is associated with an artificial intelligence (AI) model; compare, by the AI model, the key phrase or each frame of sound data to the word dictionary; and determine, by the AI model, the multimedia input is AI-generated or non-AI generated.

### FIELD OF THE INVENTION

The present invention embraces a system for automatically identifying AI-generated audio and visual media.

### BACKGROUND

In today's digital environment, multimedia and communications can be generated using artificial intelligence (AI), thus creating deepfakes that can be difficult for traditional data security techniques to identify. These deepfakes can further cause data security breaches over remote networks, user account accesses, and/or the like. Therefore, a great need exists for a system that can automatically, efficiently, and securely for automatically identifying AI-generated audio and visual media in real time or near real time before any of these data breaches can occur.

Applicant has identified a number of deficiencies and problems associated with identifying AI-generated audio and visual media. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for automatically identifying AI-generated audio and visual media is provided. In some embodiments, the system may comprise: a memory device with computer-readable program code stored thereon; at least one processing device operatively coupled to the memory device and at least one communication device, wherein executing the computer-readable code is configured to cause the at least one processing device to: receive a multimedia input from a user device; receive a key phrase from the user device; identify a user account based on the key phrase; extract and parse each frame from the multimedia input, wherein each frame is parsed for sound data; apply a word dictionary to at least one of the key phrase or each frame of the sound data, wherein the word dictionary is specific to the user account, and wherein the word dictionary is associated with an artificial intelligence (AI) model; compare, by the AI model, the key phrase or each frame of sound data to the word dictionary, wherein each frame comprises at least one of word data, frequency data, decibel data, or phonetic data; and determine, by the AI model, the multimedia input is AI-generated or non-AI generated based on the comparison of the key phrase or each frame of the sound to the word dictionary.

In some embodiments, each frame is further parsed for image data, wherein executing the computer-readable code is configured to cause the at least one processing device to: apply each frame comprising the image data to a frame-based detection model, wherein the frame-based detection model is configured to apply spatial decomposition and temporal filtering to each frame of the image data; determine, by the frame-based detection model, a signal of the multimedia input; compare each frame corresponding with a location within the signal, wherein each location corresponds to a timestamp within the multimedia input; and determine, based on the comparison, changes of low or high amplitude between each frame within the signal. In some embodiments, a high amplitude corresponds to a determination the multimedia input is AI-generated.

In some embodiments, and in an instance where the multimedia input is determined as non-AI generated, wherein executing the computer-readable code is configured to cause the at least one processing device to: identify at least one access request associated with the multimedia input, wherein the at least one access request is received in an instance before the multimedia input, in the multimedia input, or in the key phrase; and allow the at least one access request by a user associated with the multimedia input.

In some embodiments, executing the computer-readable code is configured to cause the at least one processing device to: generate, by the AI model and based on the word dictionary, an audio token associated with the user account, wherein the audio token is based on historical user data and word data; compare, by the AI model, the key phrase or each frame of the sound data to the audio token; and determine, based on the comparison of the key phrase or each frame of the sound data to the audio token, the multimedia input is AI-generated or non-AI generated.

In some embodiments, executing the computer-readable code is configured to cause the at least one processing device to: generate, based on the comparison of the key phrase or each frame of the sound to the word dictionary, a confidence score, wherein the confidence score is an average score of similarities and differences between the key phrase or each frame of the sound data and the word dictionary over a period of the multimedia input; compare the confidence score to a confidence threshold; and determine the multimedia input is AI-generated or non-AI generated based on the comparison of the confidence score to the confidence threshold. In some embodiments, the confidence score is generated based on a comparison of the key phrase or each frame of the sound to an audio token associated with the user account.

In some embodiments, executing the computer-readable code is configured to cause the at least one processing device to: generate a prompt for a user associated with the multimedia input, wherein the prompt comprises a request for a specific word within the multimedia input; transmit the prompt to the user device; receive, in response to the transmission of the prompt, a response from the user device; compare the response to the prompt; and authenticate, based on the comparison of the response to the prompt, the user of the multimedia input as the user of the user account.

In some embodiments, executing the computer-readable code is configured to cause the at least one processing device to: determine a current location of the user device; access at least one preferred location of the user account; compare the current location to the at least one preferred location; and authenticate a user of the user device based on the current location matching the at least one preferred location.

In some embodiments, executing the computer-readable code is configured to cause the at least one processing device to: determine a location-based language associated with the user account, wherein the location-based language comprises modified words; compare the key phrase or each frame of the sound data to the location-based language; and authenticate, based on the comparison of the key phrase or each frame of the sound data to the location-based language, a user of the user device is associated with the user account based on at least one match between the key phrase or each frame of the sound to the location-based language.

In some embodiments, executing the computer-readable code is configured to cause the at least one processing device to: identify, by the AI model, a current emotion feature of the key phrase or the multimedia input, wherein the current emotion feature comprises at least one of a tone, a pitch, or a speech pattern; determine, by the AI model, a normalized emotion feature of historical speech data for the user account; compare the normalized emotion feature to the current emotion feature; and authenticate a user of the user device based on the normalized emotion feature matching the current emotion feature.

In some embodiments, executing the computer-readable code is configured to cause the at least one processing device to: identify, at a first instance, an identifier associated with the multimedia input or the key phrase; compare the identifier to an authenticated identifier of the user account; and authenticate a user of the user device based on the identifier matching the authenticated identifier. In some embodiments, the identifier comprises a phone number, an account name, an IMEI number, or an address.

In some embodiments, executing the computer-readable code is configured to cause the at least one processing device to: generate a distributed ledger for the user account; collect historical communication data associated with the user account, wherein the historical communication data comprises historical multimedia inputs, historical sound data, or historical image data; and update a node on the distributed ledger at each instance historical communication data is collected.

In some embodiments, executing the computer-readable code is configured to cause the at least one processing device to: detect a change in the multimedia input, wherein the change is related to a user in an image of the multimedia input, a sound in the multimedia input, an identifier change, or a geolocation change; and automatically block the multimedia input in an instance where the change is detected.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for automatically identifying AI-generated audio and visual media, in accordance with an embodiment of the disclosure;

FIG. 2 illustrates an exemplary artificial intelligence (AI) engine subsystem architecture, in accordance with an embodiment of the disclosure

FIG. 3 illustrates a process flow for automatically identifying AI-generated audio and visual media, in accordance with an embodiment of the disclosure;

FIG. 4 illustrates a process flow for determining frames of the multimedia input to identify AI-generated or non-AI generated multimedia, in accordance with an embodiment of the disclosure;

FIG. 5 illustrates a process flow for allowing an access request in an instance where multimedia input is not AI-generated, in accordance with an embodiment of the disclosure;

FIG. 6 illustrates a process flow for determining the multimedia input is AI-generated or non-AI generated based on an audio token, in accordance with an embodiment of the disclosure;

FIG. 7 illustrates a process flow for determining the multimedia input is AI-generated or non-AI generated based on confidence score, in accordance with an embodiment of the disclosure;

FIG. 8 illustrates a process flow for authenticating a user of the multimedia input as the user of the user account based on a response from the user device, in accordance with an embodiment of the disclosure;

FIG. 9 illustrates a process flow for authenticating a user of the multimedia input as the user of the user account based on a response from the user device, in accordance with an embodiment of the disclosure;

FIG. 10 illustrates a process flow for authenticating a user based on the current location of the user device, in accordance with an embodiment of the disclosure;

FIG. 11 illustrates a process flow for authenticating a user based on a normalized emotion feature and a current emotion feature, in accordance with an embodiment of the disclosure;

FIG. 12 illustrates a process flow for authenticating a user based on an identifier and an authenticated identifier, in accordance with an embodiment of the disclosure;

FIG. 13 illustrates a process flow for updating a generating and updating a distributed ledger based on historical communication data of the user account, in accordance with an embodiment of the disclosure;

FIG. 14 illustrates a process flow for blocking the multimedia input when a change in the multimedia input is detected, in accordance with an embodiment of the disclosure;

FIG. 15 illustrates an architecture flow for generating a word dictionary and identifying sound data from the multimedia input, in accordance with an embodiment of the disclosure; and

FIG. 16 illustrates an architecture flow for determining whether the multimedia input is AI generated or non-AI generated based on one or more confidence scores and various processes, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's digital environment, multimedia and communications can be generated using artificial intelligence (AI), thus creating deepfakes that can be difficult for traditional data security techniques to identify. These deepfakes can further cause data security breaches over remote networks, user account accesses, and/or the like. Therefore, a great need exists for a system that can automatically, efficiently, and securely for automatically identifying AI-generated audio and visual media in real time or near real time before any of these data breaches can occur.

Accordingly, the present disclosure provides for receiving a multimedia input from a user device; receiving a key phrase from the user device; identifying a user account based on the key phrase; extracting and parsing each frame from the multimedia input, wherein each frame is parsed for sound data; and applying a word dictionary to at least one of the key phrase or each frame of the sound data, wherein the word dictionary is specific to the user account, and wherein the word dictionary is associated with an artificial intelligence (AI) model. Further, the disclosure provides for comparing, by the AI model, the key phrase or each frame of sound data to the word dictionary, wherein each frame comprises at least one of word data, frequency data, decibel data, or phonetic data; and determining, by the AI model, the multimedia input is AI-generated or non-AI generated based on the comparison of the key phrase or each frame of the sound to the word dictionary.

In other words, the disclosure provides a system for determining whether a video is a deepfake video, which may be used by potential mis-appropriators to gather sensitive and confidential information, to authorize data transmissions which may not have been allowed by the authorized user of an account, to open fake accounts, and/or the like. The system may create a deepfake defender framework that includes an AI model that analyzes video and audio content, and identifies patterns and anomalies that are indicative of deepfake videos and audio. The system may create a word dictionary based on user word usage, generate audio signature and voice print of users and store the word bank in a database or distributed ledger. The system may further extract audio frame-by-frame, apply a noise cancelling algorithm to perform words decibel check, frequency check, spectral features check and phonetic diversity check. Based on this extraction of data, the system may compare the current audio signatures of a user and determine if the audio signatures match past audio signatures for the same user. For video authentication, the system may apply a frame-based detection technique on each frame of video recording and compare confidence score to declare video authentication.

What is more, the present disclosure provides a technical solution to a technical problem. As described herein, the technical problem includes the identification of AI-generated multimedia. The technical solution presented herein allows for the automatic, efficient, and secure identification of AI-generated audio and visual media. In particular, the disclosure provided herein is an improvement over existing solutions to the above-identified problems in technology, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

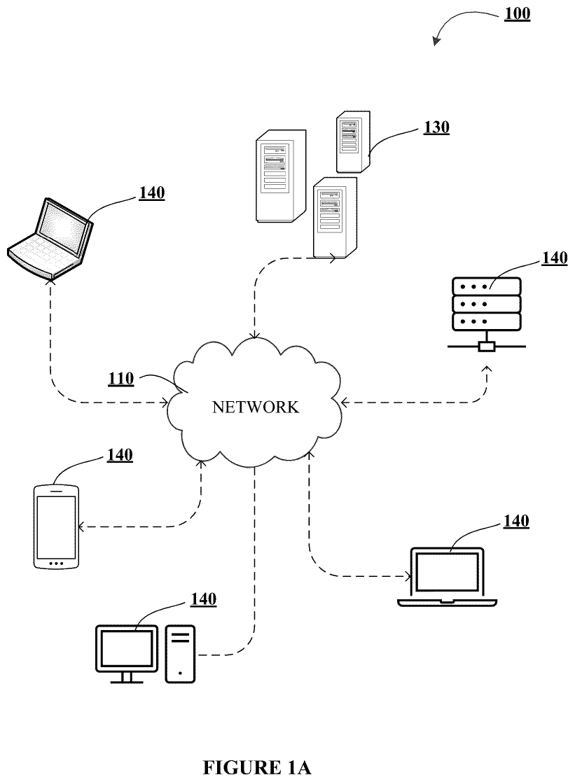

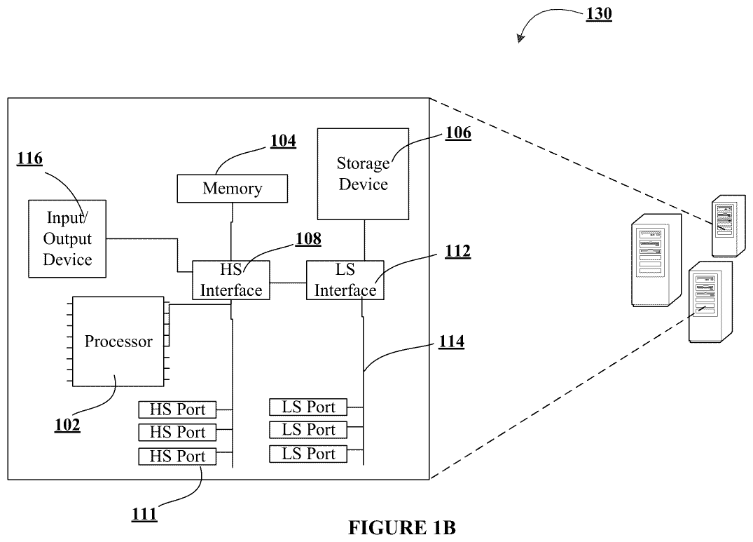

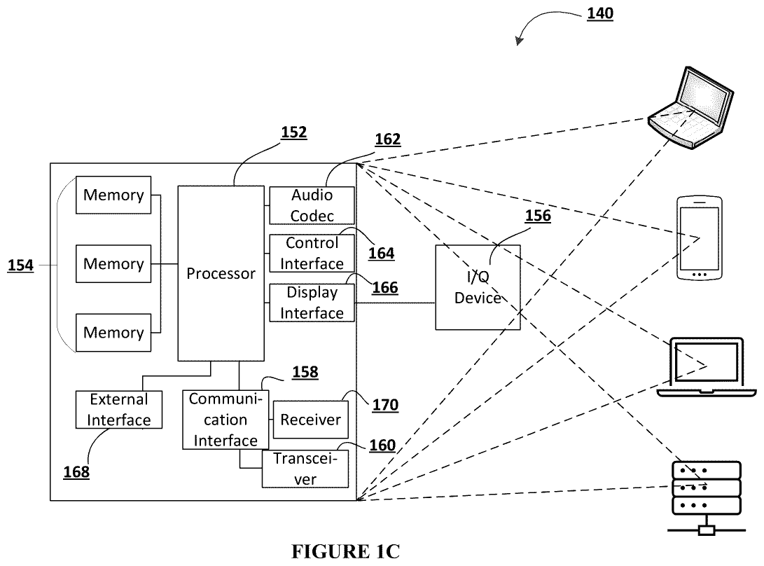

FIGS. 1A-1C illustrate technical components of an exemplary distributed computing environment for automatically identifying AI-generated audio and visual media 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

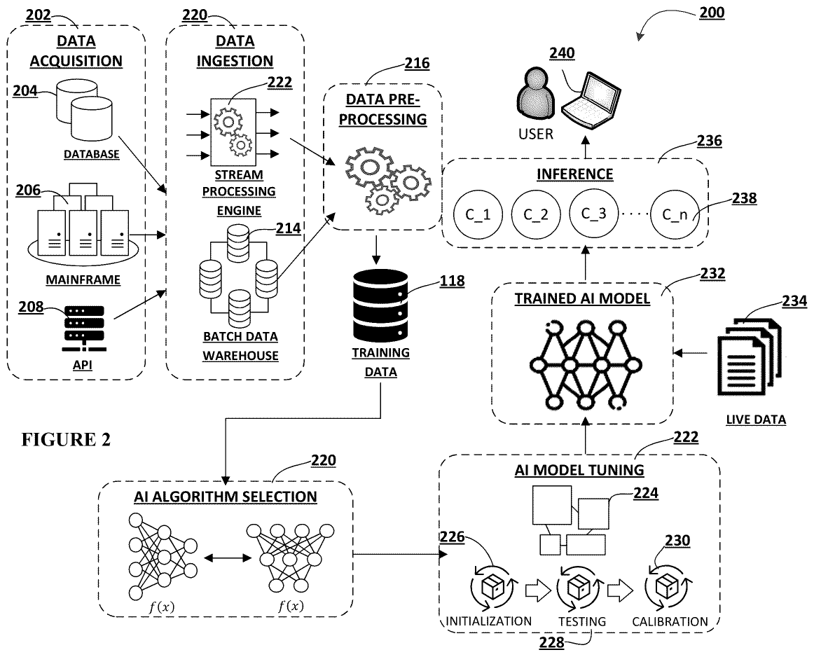

FIG. 2 illustrates an exemplary artificial intelligence (AI) engine (which may also be referred to as an AI model) subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

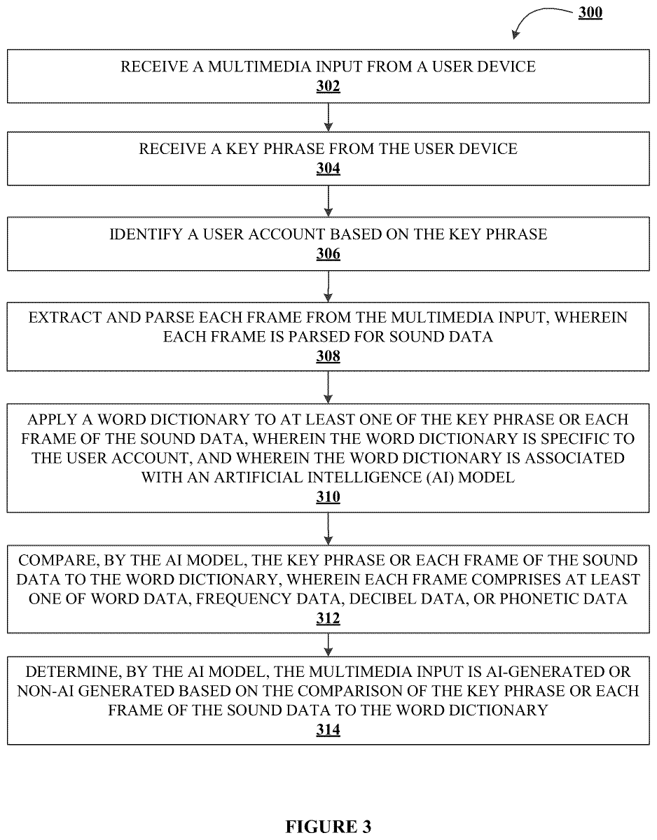

FIG. 3 illustrates a process flow 300 for automatically identifying AI-generated audio and visual media, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence model (e.g., such as the AI engine shown in FIG. 2) may perform some or all the steps described in process flow 300.

As shown in block 302, the process flow 300 may include the step of receiving a multimedia input from a user device. For example, the multimedia input may comprise a current video, a current video call, a current image and associated sound from a user device, and/or the like. In some embodiments, the multimedia input may be received from a user device (e.g., over a network) along with a request to access a user account, a resource account, a secure network, and/or the like.

As shown in block 304, the process flow 300 may include the step of receiving a key phrase from the user device. For example, the key phrase may be part of the multimedia input, may be its own input before the multimedia input is received, after the multimedia input is received, and/or the like. In some embodiments, the key phrase may comprise an authentication credential, an identifier for the user (e.g., the name of the user, account identifier, phone number, email address, and/or the like), and/or the like. In some embodiments, the key phrase may additionally comprise specific words prompted by the system, whereby the key phrases may be requested by the system via one or more prompts generated and transmitted from the system to the user device. Such an embodiment is described in further detail below.

As shown in block 306, the process flow 300 may include the step of identifying a user account based on the key phrase. For example, such a user account may be associated with the system itself, with a client of the system (e.g., an entity that is using the system to identify AI-generated audio and visual multimedia), a user of a client of the system, and/or the like. In some embodiments, the user account may be identified based on the key phrase, which may be parsed and compared to one or more key phrases associated with one or more user accounts. In some embodiments, and upon identifying a historical key phrase match for the current key phrase, the system may identify the correct user account that created the current key phrase.

As shown in block 308, the process flow 300 may include the step of extracting and parsing each frame from the multimedia input, wherein each frame is parsed for sound data. For example, the system may extract and parse the sound data from the video. In some embodiments, the sound data may comprise sound waves, sonification, pitch, volume, tempo/frequency, phonetics, decibels, and/or the like, and the sound data may be used to determine word frequency, phrase frequency, tone, pitch, emotion data, and/or the like.

As shown in block 310, the process flow 300 may include the step of applying a word dictionary to at least one of the key phrase or each frame of the sound data, wherein the word dictionary is specific to the user account, and wherein the word dictionary is associated with an artificial intelligence (AI) model. For example, the word dictionary may be specific to the user account and comprise historical sound data or word data of historical instances from the user of the user account. In some embodiments, the word dictionary may be associated with an AI model that is pre-trained on historical sound data and word dictionaries for the user account.

In some embodiments, the word dictionary may be generated by the AI model for the user account based on collecting past or historical sound data. In some embodiments, the word dictionary may be generated by the system and then input or applied to the AI model for training specific to the user account. Such a word dictionary is based on the user's word usage, and may be used by the AI model to generate audio signature(s) and/or voice print(s) of the user and store the audio signature and voice print with the word dictionary and/or within the word dictionary. In some embodiments, the audio signature and voice print may be stored in a database or index associated with the AI model.

In some embodiments, the system may apply the word dictionary to the key phrase and/or apply the key phrase to the word dictionary, and the system may determine—using the word dictionary and the associated AI model—whether the sound data of the current multimedia input matches the audio signature and/or voice print of the word bank dictionary for the user account. For example, and in an instance where the current sound data from the multimedia input matches the audio signature and/or voice print, the system may determine the current user of the multimedia input is likely the same user of the user account and thus, the multimedia input is likely not AI generated.

In some embodiments, the system may apply the word dictionary to each frame of the sound data. In some embodiments, the sound data may comprise one or more bytes of sound data by parsing and extracting the sound data from the multimedia input. In some embodiments, the AI model may determine the similarities and/or differences between the sound data and the audio signature and/or voice print. As used herein, the byte of sound data refers to data indicating an amplitude(s) (or loudness) of a sample of sound from the sound data over a period or at a specific moment in time. In some embodiments, each frame of sound data comprises at least one of word data, frequency of sound, decibel data, phonetic data (e.g., phonetic diversity check), spectral features, and/or the like.

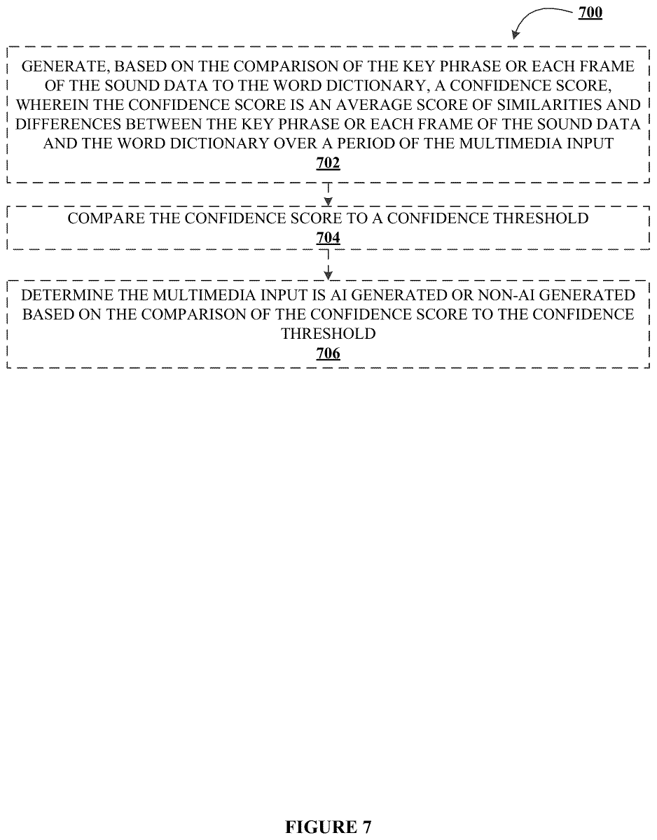

As shown in block 312, the process flow 300 may include the step of comparing, by the AI model, the key phrase or each frame of sound data to the word dictionary, wherein each frame comprises at least one of word data, frequency data, decibel data, or phonetic data. In some embodiments, the system may compare the key phrase or each frame of sound data to the word dictionary (e.g., to the audio signature and/or the voice print of the word dictionary). In some embodiments, the comparison by the AI model may determine similarities and differences between the sound data and the data of the word dictionary of historical user sound data. In some embodiments, the system may generate a confidence score and confidence threshold to determine the lowest point that the multimedia input can be confidently determined as not AI generated. Such an embodiment is described in further detail below with respect to FIG. 7.

As shown in block 314, the process flow 300 may include the step of determining, by the AI model, the multimedia input is AI-generated or non-AI generated based on the comparison of the key phrase or each frame of the sound to the word dictionary. In some embodiments, the system may determine the multimedia input is AI generated based on the comparison of only the key phrase and/or based on each frame of the multimedia input matching the voice print and/or the audio signature from the word dictionary. For instance, and where a confidence score is being used, the system may determine there is a match based on the confidence score meeting or exceeding the confidence threshold. In some embodiments, the system may compare a plurality of the frames or all the frames to the word dictionary to determine whether the multimedia input is AI generated or not AI generated.

In some embodiments, the system may determine the multimedia input is not AI generated based on the comparison of only the key phrase and/or based on each frame of the multimedia input not matching the voice print and/or the audio signature from the word dictionary. For instance, and where a confidence score is being used, the system may determine there is not a match based on the confidence score being less than the confidence threshold. Such a confidence threshold may be pre-determined by a manager of the system, by a client of the system (e.g., a manager, owner, operator, and/or the like of the network that received the multimedia input), and/or by the system itself (e.g., based on previous identifications of AI generated multimedia inputs and their associated confidence scores).

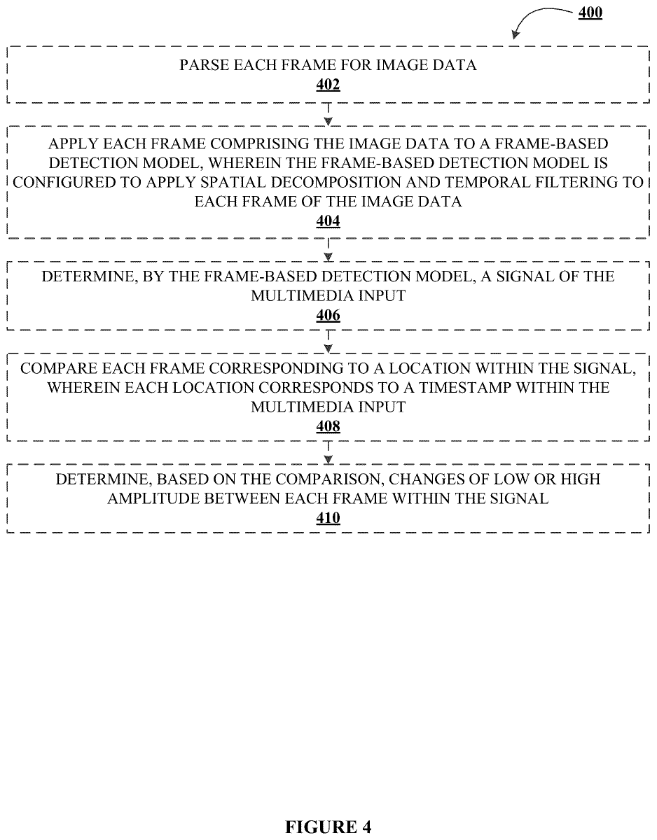

FIG. 4 illustrates a process flow 400 for determining frames of the multimedia input to identify AI-generated or non-AI generated multimedia, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence model (e.g., such as the AI engine shown in FIG. 2) may perform some or all the steps described in process flow 400.

In some embodiments, and as shown in block 402, the process flow 400 may include the step of parsing each frame for image data. For example, the image data from the multimedia input may be captured based on each individual image from the multimedia input. For example, and where the multimedia input is a video of a user, the system may capture each image or frame of the video. Each frame may be captured over pre-determined intervals (e.g., every second an image may be captured from the video, every millisecond an image may be captured, every 5 seconds an image may be captured, and/or the like). In some embodiments, the image data may be captured each time an image is determined to change (e.g., a movement of the user within the video changes, a background within the image changes, and/or the like).

In some embodiments, and as shown in block 404, the process flow 400 may include the step of applying each frame comprising the image data to a frame-based detection model, wherein the frame-based detection model is configured to apply spatial decomposition and temporal filtering to each frame of the image data. For instance, the frame-based detection model may be configured to apply spatial decomposition and temporal filtering to each frame of the image data. As used herein, the spatial decomposition refers to the process of breaking down each frame/image within the multimedia input to smaller, spatially distinct regions or components such as by a separating portions of the image into a grid with various resolutions. The distinct regions between the multiple images may be analyzed for subtle color variations in the images comprising an image of the user or what appears to be the user (e.g., which may have been generated by AI).

Further, the frame-based detection model may comprise temporal filtering which is a process for processing the data and/or signals from the image of each frame over time to remove unwanted frequencies and smoot out temporal variations, such as motion or noise. For instance, and with respect to the frames, the temporal filtering may comprise a blurring of the pixels or regions over one or more images to reduce noise and movement within the images. In this manner, and by using this spatial decomposition and temporal filtering, the frame-based detection model may identify physical characteristics of the user in the multimedia input, such as but not limited to changes in coloration of the user's physical characteristics to determine the presence of a physical rate (such as a cardiac rate) in the user. For example, the frame-based detection model can detect minor changes in skin color of the user and may, in some instances, determine the physical rate from the user within the multimedia input. Thus, and in an instance where the multimedia input was AI generated, the system may determine—using the frame-based detection model—that there is no color variation in the user's skin tone, and thus the user is AI generated and not real. In some instances, the frame-based detection model may determine the user within the multimedia input has an abnormal physical/cardiac rate and only slight color variation, and thus, may be AI generated.

In some embodiments, and as shown in block 406, the process flow 400 may include the step of determining, by the frame-based detection model, a signal of the multimedia input. For instance, the system may determine a signal using the frame-based detection model. In some embodiments, the frame-based detection model may generate a signal indicating the determined cardiac rate of the user within the multimedia input. For example, and as the frame-based detection model determines the cardiac rate of the user within the multimedia input across the frames extracted from the multimedia input, the system may generate a signal indicating the changes in the cardiac characteristics in the user's body over the time of the multimedia input (e.g., the length of the video of the multimedia input).

In some embodiments, and as shown in block 408, the process flow 400 may include the step of comparing each frame corresponding to a location within the signal, wherein each location corresponds to a timestamp within the multimedia input. In some embodiments, the system may compare each frame corresponding to a location within the signal and each location may correspond to a timestamp. For example, and where the signal is represented on an X-Y basis, the X axis may represent the time for the multimedia input and the signal may be represented on the Y axis. Thus, and as time increases on the X axis, the signal represented with amplitudes on the Y axis may change (increase or decrease). In some embodiments, the signal may be represented as a single line in the graph. Further, and in some embodiments, as the signal is represented as a single line in the graph, any major fluctuations between amplitudes over a small period (e.g., a sharp increase by 100 beats per minute while the user appears to be sitting down in the multimedia input) may indicate the multimedia input is AI generated because the determined physical/cardiac rate is false or fake. Additionally, and similarly, sharp decreases between amplitudes over a small period may also indicate the multimedia input is AI generated.

In some embodiments, and as shown in block 410, the process flow 400 may include the step of determining, based on the comparison, changes of low or high amplitude between each frame within the signal. For example, and as mentioned briefly above, the system may determine normal amplitudes and amplitude changes over periods of time within the multimedia input, and based on these normal amplitude changes, any amplitude changes that are outside of this normalized behavior may be flagged as potentially being AI generated.

In some embodiments, the amplitude taken at a particular time may be used to determine whether the multimedia input is AI generated. For example, a high amplitude may correspond to a determination the multimedia input is AI generated. For example, such a high amplitude may indicate a user's physical/cardiac rate is over 200 beats per a minute while the user appears to be sitting down and at rest in the multimedia input. Likewise, and where the amplitude is extremely low, the system may also determine the multimedia input is AI generated. For example, such a low amplitude may indicate a user's physical/cardiac rate is less than 50 beats per a minute and thus, the user's physical/cardiac rate may indicate a major physical condition or that the multimedia input is AI generated as video of a user with a consistently low physical/cardiac rate may be AI generated.

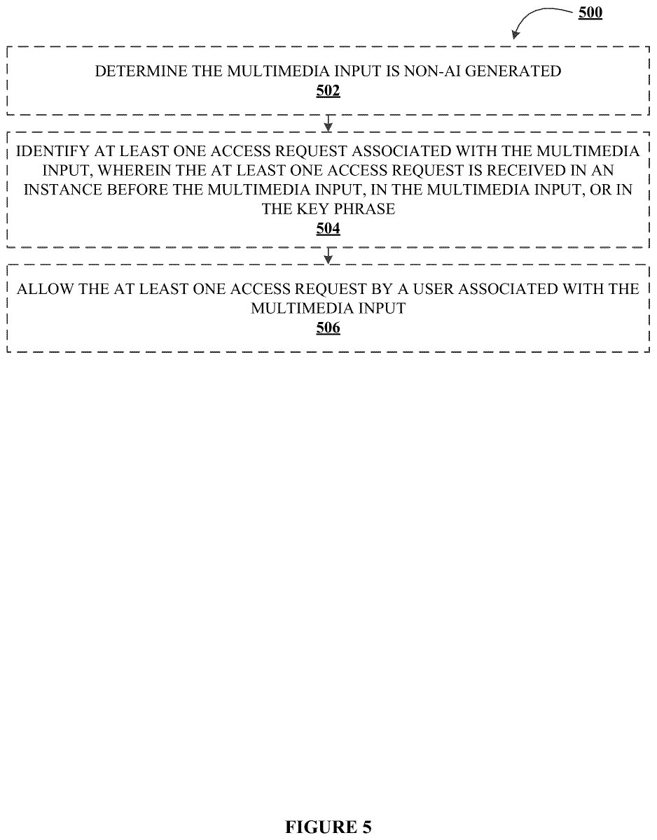

FIG. 5 illustrates a process flow 500 for allowing an access request in an instance where multimedia input is not AI-generated, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence model (e.g., such as the AI engine shown in FIG. 2) may perform some or all the steps described in process flow 500.

In some embodiments, and as shown in block 502, the process flow 500 may include the step of determining the multimedia input is non-AI generated. For example, and based on at least the processes described herein with respect to FIGS. 3 and/or 4, the system may determine the multimedia is not AI generated.

In some embodiments, and as shown in block 504, the process flow 500 may include the step of identifying at least one access request associated with the multimedia input, wherein the at least one access request is received in an instance before the multimedia input, in the multimedia input, or in the key phrase. For example, and in some such embodiments, the system may identify at least one access request from the user of the multimedia input. In some embodiments, this access request may comprise a request to access user account data associated with the user account indicated in the multimedia input (e.g., a user account identified by the user within the multimedia input), a request to access a resource account associated with a user account, a request to access a secure network, and/or the like. Thus, and in some embodiments, the access request may comprise user identifying data, such as but not limited to an authentication credential (e.g., a username, a password, a phone number unique to a user account, an email address, and/or the like).

Additionally, and in some embodiments, the access request may be identified in an instance before the multimedia input is received (e.g., the user of the multimedia input may input their authentication credentials, phone number, email address, and/or the like, before transmitting the multimedia input). In some embodiments, the access request may be identified from the within the multimedia input (e.g., after transmitting the multimedia input at least at a first instance, the user within the multimedia input may state their authentication credentials, phone number, email address, and/or the like, as a voice input within the multimedia input). In some such embodiments, the multimedia input may a real time video of the user (e.g., a video call) and the user may be prompted to give an access request vocally, by keystroke entry, and/or the like. In some embodiments, the access request may be identified from the key phrase generated and received from the user of the multimedia input.

In some embodiments, and as shown in block 506, the process flow 500 may include the step of allowing the at least one access request by a user associated with the multimedia input. For example, the system may automatically allow the at least one access request in an instance where the multimedia input is verified as not being AI generated. In some embodiments, the system may additionally request a user authentication beyond the determination that the multimedia input is not AI generated. For example, such an authentication may comprise an input of authentication credentials by the user, a dual factor authentication, a facial recognition process for the user, and/or the like, to verify the user matches the user account identified in the access request.

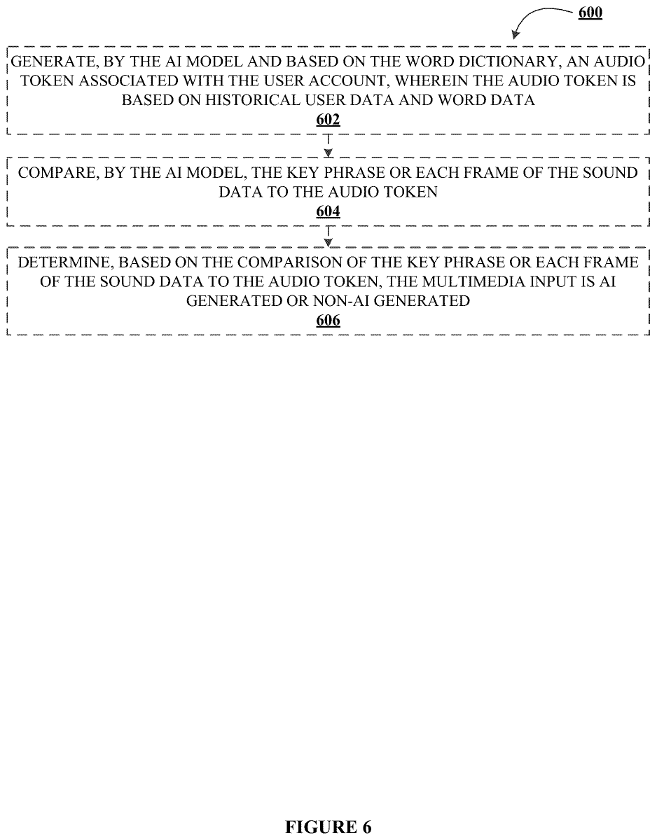

FIG. 6 illustrates a process flow 600 for determining the multimedia input is AI-generated or non-AI generated based on an audio token, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence model (e.g., such as the AI engine shown in FIG. 2) may perform some or all the steps described in process flow 600.

In some embodiments, and as shown in block 602, the process flow 600 may include the step of generating, by the AI model and based on the word dictionary, an audio token associated with the user account, wherein the audio token is based on historical user data and word data. For example, and in some such embodiments, the system may generate—using the AI model—an audio token for the user account based on the word dictionary generated for the same user account. In this manner, the audio token may comprise a normalized representation of the validated user of the user account's historical words and phrases. In some embodiments, the audio token may be generated by the AI model and using the word dictionary of historical words, phrases, and/or sound data collected from historical instances of the user interacting with the system and/or interacting with a client of the system.

In some embodiments, and as shown in block 604, the process flow 600 may include the step of comparing, by the AI model, the key phrase or each frame of the sound data to the audio token. For instance, and in some embodiments, the system may compare the current sound data, which may comprise the current key phrase, to the audio token. In some embodiments, the audio token may comprise a voice print(s) of the current sound data and/or the current key phrase. In some such embodiments, the voice print(s) may comprise audio characteristics specific to the user, such as the physical characteristics identified within the vocal data collected from the user which is used to generate the voice print as a digital model of the user's speech comprising unique vocal traits like pitch, tone, cadence, and/or timbre.

Thus, and in some embodiments, the AI model may may compare the extracted sound data from the multimedia input and/or the key phrase collected at the current multimedia input instance to the audio token. Such sound data may comprise current vocal data (e.g., current pitch, tone, cadence, and/or timbre) which may be compared on a one-to-one basis to the vocal data present in the voice print.

In some embodiments, and as shown in block 606, the process flow 600 may include the step of determining, based on the comparison of the key phrase or each frame of the sound data to the audio token, the multimedia input is AI generated or non-AI generated. For example, and in some such embodiments, the system may determine the multimedia input is AI generated based on the current vocal data not matching the voice print for the user of the user account. Additionally, and in contrast, the system may determine the multimedia input is not AI generated based on the voice print matching the vocal data from the multimedia input and/or the current key phrase. In some embodiments, the system may determine the multimedia input is not AI generated based on the processes described herein with respect to FIGS. 3, 4, and 5, but the system may determine the real user in the multimedia input is not the verified user of the user account (e.g., the authentication credentials for the user account were misappropriated).

FIG. 7 illustrates a process flow 700 for determining the multimedia input is AI-generated or non-AI generated based on confidence score, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700. In some embodiments, an artificial intelligence model (e.g., such as the AI engine shown in FIG. 2) may perform some or all the steps described in process flow 700.

In some embodiments, and as shown in block 702, the process flow 700 may include the step of generating, based on the comparison of the key phrase or each frame of the sound data to the word dictionary, a confidence score, wherein the confidence score is an average score of similarities and differences between the key phrase or each frame of the sound data and the word dictionary over a period of the multimedia input. For example, and in some embodiments, the system may generate a confidence score for determining whether the multimedia input is AI generated and/or whether the user within the multimedia input matches the validated user for the user account.

For example, and in some embodiments, the system may generate a confidence score for the current multimedia input based on the comparison of the key phrase and/or the sound data collected from the multimedia input compared to the word dictionary (e.g., the voice print and/or the audio signature) For example, and as described briefly above in FIG. 6, the system may compare the vocal data from the multimedia input to the voice print for the user to determine whether the vocal data matches the voice print of the user account. In some such embodiments, the better or closer the match between the vocal data and the voice print, the higher the confidence score.

In some embodiments, the audio signature refers to unique characteristics specific to the user and their speech patterns. For example, such audio signature data may be based on at least one of ticks (e.g., clicking teeth, sucking teeth, and/or the like), long pauses between words, decibels at portions of specific words, duration percentage within each word (e.g., the typical duration of each syllable within a word), location-based words (e.g., location based slang and accuracy of language), and/or the like. In some such embodiments, the audio signature for the user may be compared to the key phrase and/or the multimedia input and based on the level of matching the audio signature to the key phrase and/or the multimedia input, the system may generate a confidence score. In some such embodiments, the closer the match between the audio signature to the key phrase and/or the multimedia input, the higher the confidence score.

In some embodiments, and when comparing both the audio signature and the voice print to the key phrase and/or the multimedia input, the audio signature and the voice print may be weighted the same to determine the confidence score. Thus, and in some such embodiment, the confidence score may be average score of confidence scores for the audio signature and the voice print.

In some embodiments, and as shown in block 704, the process flow 700 may include the step of comparing the confidence score to a confidence threshold. In some such embodiments, the confidence threshold may be pre-determined by an owner/manager of the system, an owner/manager of a client of the system (such a client using the system to identify AI generated or non-AI generated multimedia inputs), by the system itself (based on previous instances of verified AI generated and non-AI generated multimedia inputs), and/or the like. In such embodiments, the confidence threshold may be used as a threshold for determining the multimedia input is likely AI generated or not AI generated. In some embodiments, and where the determination that the multimedia input has been AI generated or not AI generated, then the system may use the confidence threshold to determine whether the user in the multimedia input is the verified user of the user account (i.e., in an instance where the multimedia input is determined as not AI generated).

In some embodiments, and as shown in block 706, the process flow 700 may include the step of determining the multimedia input is AI generated or non-AI generated based on the comparison of the confidence score to the confidence threshold. Thus, and in some such embodiments, the system may determine the multimedia input is AI generated in an instance where the confidence score does not meet or exceed the confidence threshold. In contrast, the system may determine the multimedia input is not AI generated in an instance where the confidence score meets or exceeds the confidence threshold.

In some embodiments, and where the system is determining whether the user in the multimedia input is the verified user of the user account, the system may authenticate the multimedia input user in an instance where the confidence score meets or exceeds the confidence threshold. In contrast, the system may determine the multimedia input user is not the verified user of the user account in an instance where the confidence score is less than the confidence threshold.

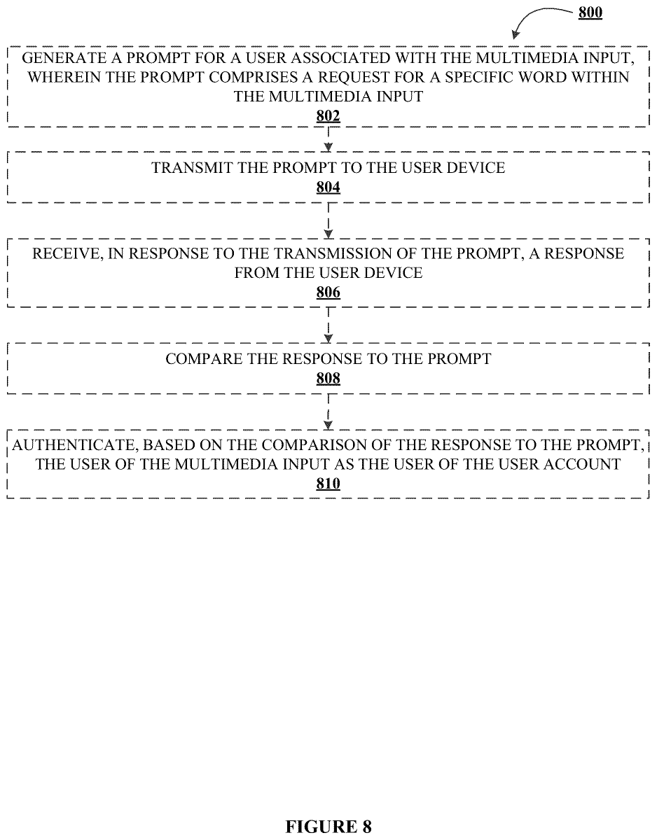

FIG. 8 illustrates a process flow 800 for authenticating a user of the multimedia input as the user of the user account based on a response from the user device, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIG. 1A-1C) may perform the steps of process 800. In some embodiments, an artificial intelligence model (e.g., such as the AI engine shown in FIG. 2) may perform some or all the steps described in process flow 800.

In some embodiments, and as shown in block 802, the process flow 800 may include the step of generating a prompt for a user associated with the multimedia input, wherein the prompt comprises a request for a specific word within the multimedia input. For instance, and in some such embodiments, the system may generate a prompt for the user of the multimedia input, wherein the prompt may request a particular vocal input from the user. For example, the prompt may request the multimedia input user to state a key phrase, to state their authentication credential(s), to state their phone number, to state a particular word used to compare to the audio signature and/or the voice print. In some embodiments, the prompt may comprise a sound output (which may be transmitted to a user device associated with the multimedia input and played over the speaker of the user device), a graphical interface component (e.g., which may configure the user device's graphical user interface to display the prompt in a text or picture format), and/or the like.

In some embodiments, and as shown in block 804, the process flow 800 may include the step of transmitting the prompt to the user device. For example, and as mentioned briefly above, the prompt may be packaged as computer-readable text by the system and the package of computer-readable text may be transmitted over a network associated with the system to a user device used to generate the multimedia input. The prompt—as the computer-readable text—may trigger an automatic configuration of the receiving user device's graphical user interface to display or play the prompt at the user device's graphical user interface and/or the user device's speakers.

In some embodiments, and as shown in block 806, the process flow 800 may include the step of receiving, in response to the transmission of the prompt, a response from the user device. For instance, and in some such embodiments, the system may receive—based on the user at the user device generating an input at the user device in response to the prompt—the response to the prompt from the user device. In some embodiments, the response may comprise sound data, image data, and/or video data captured at the user device and transmitted from the user device via a network to the system. In some embodiments, the response may comprise key phrase(s) from the user, the multimedia input, authentication credentials, phone number, user identifying data, and/or the like.

In some embodiments, and as shown in block 808, the process flow 800 may include the step of comparing the response to the prompt. For example, and in some such embodiments, the system may compare the response to the prompt to determine whether the response meets the request within the prompt. For example, and where the prompt requested the user of the multimedia input give their authentication credentials, then the system may compare the received response to determine if authentication credentials were received and/or match the authentication credentials for the expected user account. Additionally, and by of example, where the prompt request a particular key phrase (such as the word “transaction”), the system may determine if the received response comprises sound data of the word “transaction.”

In some embodiments, and as shown in block 810, the process flow 800 may include the step of authenticating, based on the comparison of the response to the prompt, the user of the multimedia input as the user of the user account. For example, and in some such embodiments, the system may authenticate the user of the multimedia input as the user of the user account based on the response matching the expected response for the prompt. In some embodiments, the system may use the AI model with the word dictionary (e.g., the voice print and/or the audio signature) to authenticate the multimedia input user as the user of the user account. Further, and in some embodiments, the response may comprise authentication credentials to authenticate the multimedia input user as the user of the user account, where the authentication credentials received may be compared to expected authentication credentials for an already identified user account. For example, and in some embodiments, the system may identify a user account based on matching a phone number associated with the received multimedia input (e.g., where the multimedia input was generated and transmitted from a mobile device) and upon receiving the authentication credentials and matching the authentication credentials to the known user account, the system may authenticate the user.

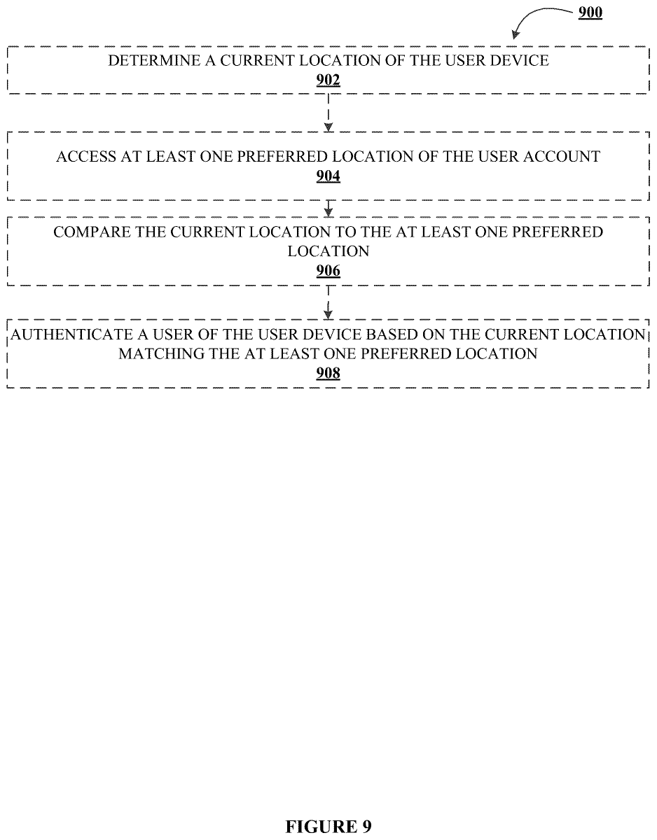

FIG. 9 illustrates a process flow 900 for authenticating a user of the multimedia input as the user of the user account based on a response from the user device, in accordance with an embodiment of the disclosure. In some embodiments, a system (e.g., similar to one or more of the systems described herein with respect to FIGS. 1A-1C) may perform one or more of the steps of process flow 900. For example, a system (e.g., the system 130 described herein with respect to FIG. 1A-1C) may perform the steps of process 900. In some embodiments, an artificial intelligence model (e.g., such as the AI engine shown in FIG. 2) may perform some or all the steps described in process flow 900.

In some embodiments, and as shown in block 902, the process flow 900 may include the step of determining a current location of the user device. For example, and in some such embodiments, the system may determine a current location of the user device that generated and/or transmitted the multimedia input by receiving geo-coordinate information from the user device (e.g., where the user device is configured to capture global position data, from cell towers located near the user device, and/or the like), by receiving user input comprising current location information of the user device, and/or the like. In some embodiments, the system may automatically request location data of the user device upon receiving the multimedia input and/or upon receiving a user input before the multimedia input (e.g., an authentication credential, a login by the user, a phone number from the user, and/or the like).

In some embodiments, and as shown in block 904, the process flow 900 may include the step of accessing at least one preferred location of the user account. For instance, and in some such embodiments, the system may access at least one preferred location associated with the user account, where the at least one preferred location is based on historical locations the verified user of the user account has transmitted previous multimedia inputs from, accessed the user account from, accessed resource accounts from, and/or the like. In some embodiments, these preferred locations may comprise the verified user's home address, work location, city of residence, and/or the like.

In some embodiments, the one or more preferred locations for the user account may be stored in a database or index and stored with the user account identifier. Thus, and in some such embodiments, the system may access the database or index, collect the one or more preferred locations for the user account, and then compare the one or more preferred locations to the current location.

In some embodiments, and as shown in block 906, the process flow 900 may include the step of comparing the current location to the at least one preferred location. For example, and in some such embodiments, the current location may be compared to the one or more preferred locations. Such an authentication based on the current location is described in further detail below.

In some embodiments, and as shown in block 908, the process flow 900 may include the step of authenticating a user of the user device based on the current location matching the at least one preferred location. In some such embodiments, and in an instance where the current location matches at least one of the preferred locations, the system may authenticate the user of the user device as the verified user of the user account. In some embodiments, and where the current location does not match any of the one or more preferred locations, the system may step up the authentication requirements for the user of the user device (e.g., require dual factor authentication, require more key phrases to compare with the voice print and/or the audio signature, and/or the like). In some embodiments, and where the current location does not match any of the one or more preferred locations, the system may automatically block the user device from completing their access request and/or block the multimedia input from being received by the system and/or analyzed by the system.

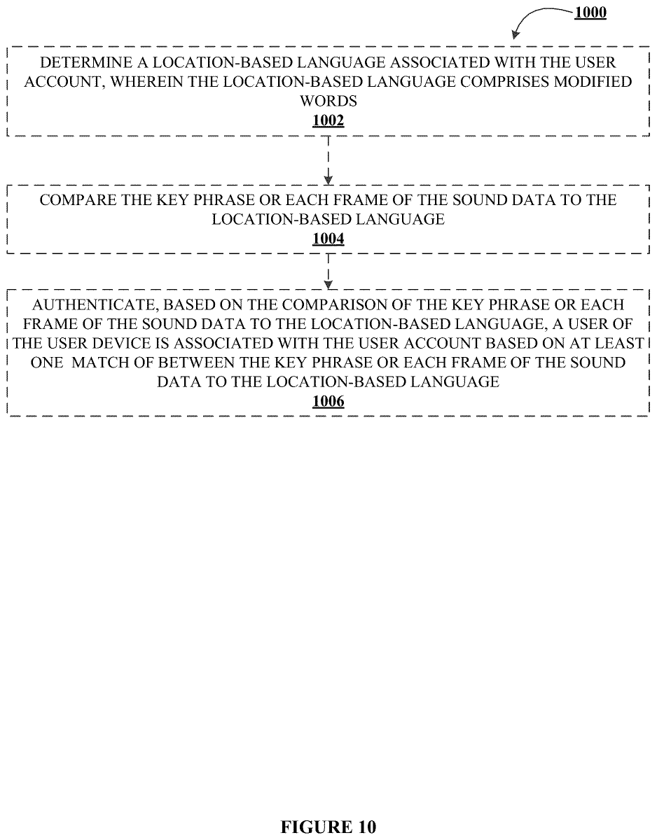

FIG. 10 illustrates a process flow 1000 for authenticating a user based on the current location of the user device, in accordance with an embodiment of the disclosure. In some embodiments, a system (e.g., similar to one or more of the systems described herein with respect to FIGS. 1A-1C) may perform one or more of the steps of process flow 1000. For example, a system (e.g., the system 130 described herein with respect to FIG. 1A-1C) may perform the steps of process 1000. In some embodiments, an artificial intelligence model (e.g., such as the AI engine shown in FIG. 2) may perform some or all the steps described in process flow 1000.

In some embodiments, and as shown in block 1002, the process flow 1000 may include the step of determining a location-based language associated with the user account, wherein the location-based language comprises modified words. For example, and as described briefly above, the system may determine a location-based language for the user account based on historical sound data collected and the speech patterns extracted from the historical sound data. In other words, the system may determine whether the verified user of the user account practices any slang language, lingo, dialect, or jargon.

In some embodiments, the location-based language for the user account may be stored in a database or index associated with the user account. For example, and similar to the database or index used to store the preferred location(s) for the user account, the system may store each word or phrase identified as location-based language for the user account with the user account identifier. In this manner, the system may collect and determine all the location-based language data the verified user of the user account has used in the past.

In some embodiments, and as shown in block 1004, the process flow 1000 may include the step of comparing the key phrase or each frame of the sound data to the location-based language. For instance, the system may compare at least one of the key phrase(s) and/or the sound data from the multimedia input to the location-based language stored for the user account. In an instance where the key phrase(s) and/or the sound data comprises a match to the location-based language for the user account, the system may determine the user of the multimedia input is the verified user of the user account, is not the verified user (e.g., has misappropriated the user account data or authentication credentials), the multimedia input is AI generated or not-AI generated, and/or the like.

In some embodiments, and as shown in block 1006, the process flow 1000 may include the step of authenticating, based on the comparison of the key phrase or each frame of the sound data to the location-based language, a user of the user device is associated with the user account based on at least one match between the key phrase or each frame of the sound data to the location-based language. For instance, and in some such embodiments, the system may authenticate the user of the user device as the user of the user account based on determining the key phrase(s) and/or the multimedia input comprise the same location-based language as the historical location-based language known for the user account. For example, and in some embodiments, the system may request—using a prompt—a specific key phrase from the user which may include a specific word the user account has been known to use a location-based language (e.g., the user account may have previous instances of saying “firefly” instead of the other popular phrase “lightning bug” and the prompt may request the user to “name the bug that lights up at night”) to confirm whether the user of the multimedia input has the same location-based language as the verified user.

In some embodiments, the system may require at least one match between the location-based language of the user account and the sound data in the current key phrase(s) and/or the multimedia input to authenticate the user. In some embodiments, the system may require a minimum number of matches to authenticate the user. In some embodiments, the requirement for the location-based language may dynamically change based on historical sound data collected for the verified user. For example, the system may require an average number of location-based language terms or phrases by the multimedia input user, and this average number may be based on a historical average particular to the user account based on historical sound data and key phrases.

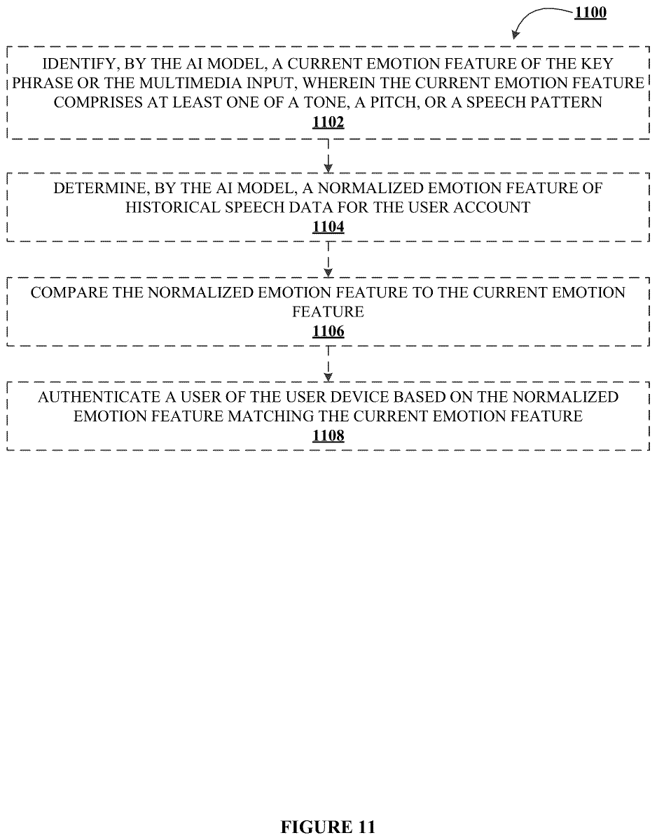

FIG. 11 illustrates a process flow 1100 for authenticating a user based on a normalized emotion feature and a current emotion feature, in accordance with an embodiment of the disclosure. In some embodiments, a system (e.g., similar to one or more of the systems described herein with respect to FIGS. 1A-1C) may perform one or more of the steps of process flow 1100. For example, a system (e.g., the system 130 described herein with respect to FIG. 1A-1C) may perform the steps of process 1100. In some embodiments, an artificial intelligence model (e.g., such as the AI engine shown in FIG. 2) may perform some or all the steps described in process flow 1100.

In some embodiments, and as shown in block 1102, the process flow 1100 may include the step of identifying, by the AI model, a current emotion feature of the key phrase or the multimedia input, wherein the current emotion feature comprises at least one of a tone, a pitch, or a speech pattern. For example, and in some such embodiments, the system may identify—using the AI model—a current emotion feature for the key phrase and/or the multimedia input, wherein the emotion feature refers to the data indicating the kinds of emotions the user may currently be feeling. Such emotion features may be identified by the system based on the collected sound data from the key phrase(s) and/or the multimedia input. In some embodiments, the emotion features can comprise tone data, pause data, pitch, speech patterns, and/or the like. For example, the emotion features may be used to determine the current emotion of the multimedia input user, and based on the identified emotion(s), the system may determine whether the multimedia input user is acting normal with respect to historical emotion(s) of the verified user of the user account.

In some embodiments, and as shown in block 1104, the process flow 1100 may include the step of determining, by the AI model, a normalized emotion feature of historical speech data for the user account. For example, and in some such embodiments, the system may determine—using the AI model—a normalized or average emotion feature for the verified user of the user account. For example, if the verified user is typically calm and speaks clearly with an event tone and pitch, and without long pauses between words, then the normalized emotion feature may reflect this data.

In some embodiments, and as shown in block 1106, the process flow 1100 may include the step of comparing the normalized emotion feature to the current emotion feature. For example, and in some such embodiments, the system may compare the normalized emotion feature to the current emotion feature (e.g., may compare the data within the normalized emotion feature to the data collected in the current emotion feature), to determine whether the emotions of the current multimedia input user and the verified user match. In some embodiments, the system may not require an exact match, and instead may use a confidence score to indicate the similarities and differences between the normalized emotion feature and the current emotion feature, where the greater the match, the higher the confidence score. In some such embodiments, the confidence score for the current emotion feature may be compared to a pre-determined confidence threshold, where the confidence threshold may be pre-determined by a client of the system, by a user of the client (e.g., the verified user), by a manager/operator of the system, and/or by the system itself based on historical emotion feature matching and authentication of verified users.

In some embodiments, and as shown in block 1108, the process flow 1100 may include the step of authenticating a user of the user device based on the normalized emotion feature matching the current emotion feature. For instance, and in some such embodiments, the system may authenticate the current multimedia input user as the verified user of the user account based on the current emotion feature matching the normalized emotion feature. Additionally, and as mentioned above, the system may require an exact matching or a confidence score and confidence threshold to determine whether the current emotion feature matches the normalized emotion feature. In some embodiments, the system may determine the current emotion feature matches, or the confidence score meets or exceeds the confidence threshold, and thus, the current multimedia input user is authenticated. In some embodiments, and where the current emotion feature does not match, or the confidence score is less than the confidence threshold, the system may determine the current multimedia input user is not authenticated for the user account.

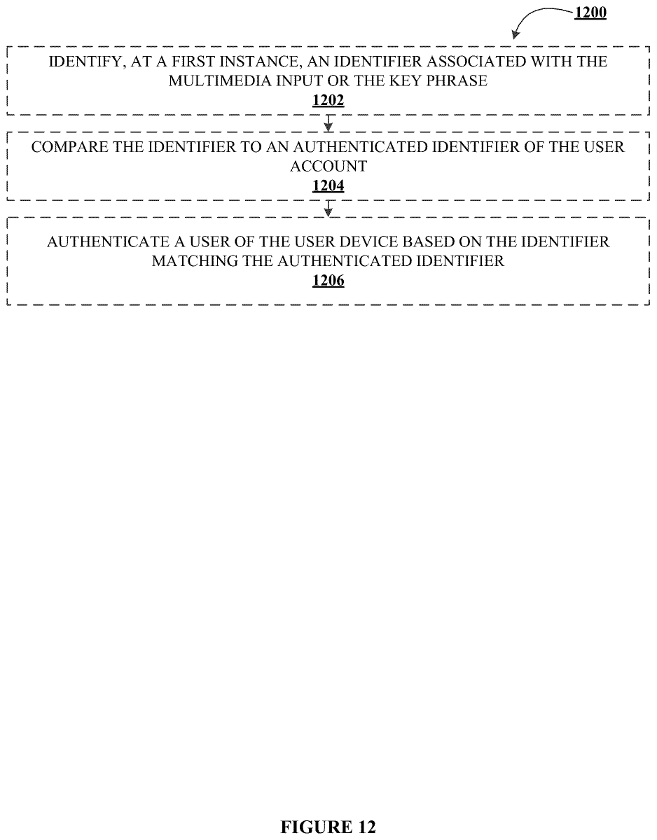

FIG. 12 illustrates a process flow 1200 for authenticating a user based on an identifier and an authenticated identifier, in accordance with an embodiment of the disclosure. In some embodiments, a system (e.g., similar to one or more of the systems described herein with respect to FIGS. 1A-1C) may perform one or more of the steps of process flow 1200. For example, a system (e.g., the system 130 described herein with respect to FIG. 1A-1C) may perform the steps of process 1200. In some embodiments, an artificial intelligence model (e.g., such as the AI engine shown in FIG. 2) may perform some or all the steps described in process flow 1200.

In some embodiments, and as shown in block 1202, the process flow 1200 may include the step of identifying, at a first instance, an identifier associated with the multimedia input or the key phrase. For example, and in some embodiments, the system may identify—at an instance before receiving the multimedia input—an identifier associated with multimedia input and/or the key phrase. For example, and in some such embodiments, the identifier may comprise a unique string of characters that uniquely identifies the user device, the user account, and/or the like. In some embodiments, the identifier may comprise a phone number, an account name, an IMEI number, an email address, a real-world address, and/or the like.

In some embodiments, and as shown in block 1204, the process flow 1200 may include the step of comparing the identifier to an authenticated identifier of the user account. For instance, and in some such embodiments, the system may compare the identifier to an authenticated identifier associated with the user account. In some embodiments, and in an instance where a user account has already been identified by the system (e.g., in an instance where the multimedia input user has input authentication credentials identifying a user account, an email address identifying the user account, and/or the like), then the system may determine whether the authenticated identifier matches the current identifier. In some such embodiments, the system may require an exact match between the identifier and the authenticated identifier.

In some embodiments, and as shown in block 1206, the process flow 1200 may include the step of authenticating a user of the user device based on the identifier matching the authenticated identifier. For instance, and in some such embodiments, the system may authenticate the multimedia input user as the verified user of the user account based on the identifier matching the authenticated identifier. For example, and in some such embodiments, if the multimedia input user generates the multimedia input at a mobile device comprising a particular phone number, and that phone number is used as the identifier here, the system may compare the identifier to the authenticated identifier (which may comprise the exact same number) and determine the multimedia input user is likely the verified user. In some embodiments, the process described herein with respect to FIG. 12 may occur before the processes described herein to determine whether the multimedia input is AI generated or non-AI generated (e.g., FIGS. 3-7).

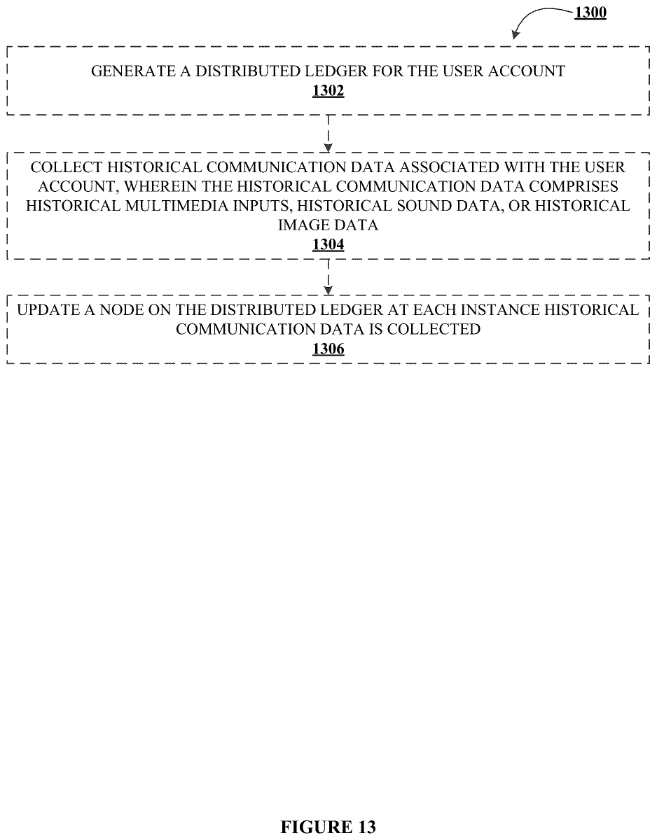

FIG. 13 illustrates a process flow 1300 for updating a generating and updating a distributed ledger based on historical communication data of the user account, in accordance with an embodiment of the disclosure. In some embodiments, a system (e.g., similar to one or more of the systems described herein with respect to FIGS. 1A-1C) may perform one or more of the steps of process flow 1300. For example, a system (e.g., the system 130 described herein with respect to FIG. 1A-1C) may perform the steps of process 1300. In some embodiments, an artificial intelligence model (e.g., such as the AI engine shown in FIG. 2) may perform some or all the steps described in process flow 1300.

In some embodiments, and as shown in block 1302, the process flow 1300 may include the step of generating a distributed ledger for the user account. For example, and in some such embodiments, the system may generate and/or update an already generated distributed ledger for the user account. In other words, the system may generate and/or update a distributed ledger specific to user account, and the distributed ledger may be a record of each interaction and communication received from a user associated with the user account. For instance, each response, multimedia input, sound data, image data, and/or key phrase received from a user associated with the user account may be logged in the distributed ledger with a timestamp of the interaction.

In some embodiments, and as shown in block 1304, the process flow 1300 may include the step of collecting historical communication data associated with the user account, wherein the historical communication data comprises historical multimedia inputs, historical sound data, or historical image data. For example, and in some such embodiments, the system may collect all the historical communication data associated with the user account to generate the distributed ledger for the user account. In some such embodiments, the distributed ledger may comprise a node for each session the historical communication data was received with a timestamp(s) for the session. In some embodiments, the timestamps of each node may comprise a start time and an end time for the session, and the session may comprise all the communication data received between a user device's initial request to transmit a multimedia input, key phrase, authentication credential, or identifier, until an end time of the session (e.g., allowing the access request and/or blocking the access request). In some embodiments, each node may comprise location identifiers for each historical communication instance.

In some embodiments, and as shown in block 1306, the process flow 1300 may include the step of updating a node on the distributed ledger at each instance historical communication data is collected. For example, and in some such embodiments, the system may add a new node to the distributed ledger at each instance historical communication data is collected. In some embodiments, the system may update a node on the distributed ledger each instance current communication data is collected for a current session, wherein each node may comprise a specific session and its associated data, such as but not limited to sound data, image data, multimedia input, key phrase(s), location data, and/or the like. In some embodiments, the distributed ledger may comprise nodes for AI generated multimedia inputs that have been identified by the system. In this manner, and in some such embodiments, the distributed ledger may keep a complete log of each multimedia input and communication received for a user account, including misappropriation-based or fake communications.

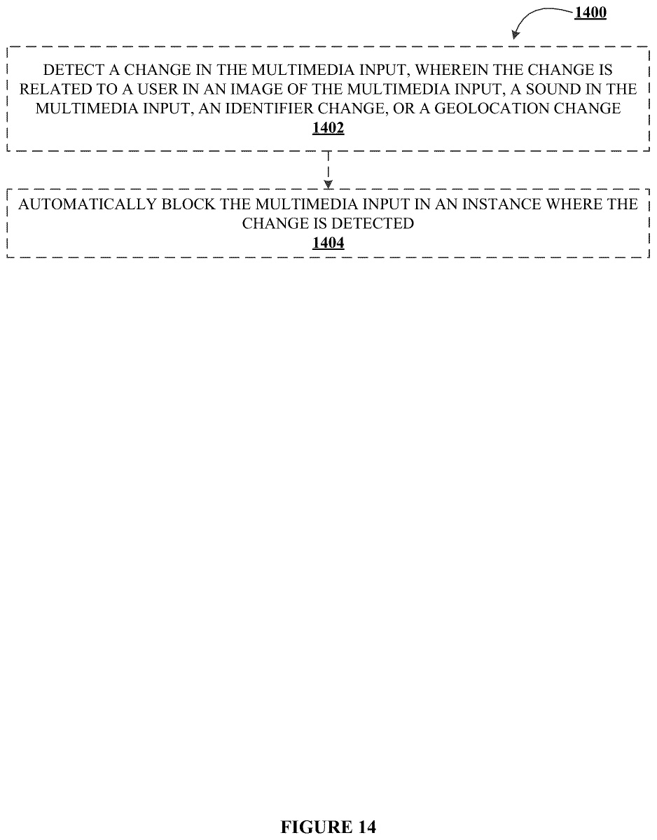

FIG. 14 illustrates a process flow 1400 for blocking the multimedia input when a change in the multimedia input is detected, in accordance with an embodiment of the disclosure. In some embodiments, a system (e.g., similar to one or more of the systems described herein with respect to FIGS. 1A-1C) may perform one or more of the steps of process flow 1400. For example, a system (e.g., the system 130 described herein with respect to FIG. 1A-1C) may perform the steps of process 1400. In some embodiments, an artificial intelligence model (e.g., such as the AI engine shown in FIG. 2) may perform some or all of the steps described in process flow 1400.

In some embodiments, and as shown in block 1402, the process flow 1400 may include the step of detecting a change in the multimedia input, wherein the change is related to a user in an image of the multimedia input, a sound in the multimedia input, an identifier change, or a geolocation change. For example, and in some such embodiments, the system may detect a current change in the multimedia input in real time or near real time to the change occurring. For example, such a change may comprise the multimedia input's user's appearance changing (e.g., an item of clothing changing, a physical characteristic changing), a background changing, a background sound changing, a change to the identifier (e.g., the user device changing, phone number changing, and/or the like), a change to the user device's location (e.g., changing cities rapidly or too quickly, countries, and/or the like), and/or the like.

In some embodiments, the change may be detected by the AI model analyzing the multimedia input. In some embodiments, the change to the appearance of the user in the multimedia input and/or the background in the multimedia input may be detected by the frame-based detection model.

In some embodiments, and as shown in block 1404, the process flow 1400 may include the step of automatically blocking the multimedia input in an instance where the change is detected. For example, and in some such embodiments, the system may automatically block the multimedia input and any other such communications from the user device upon identifying the change in the multimedia input or the change to the user device. Such an abrupt change may indicate a man in the middle attack, a misappropriation attempt, an unauthorized redirect, and/or the like.

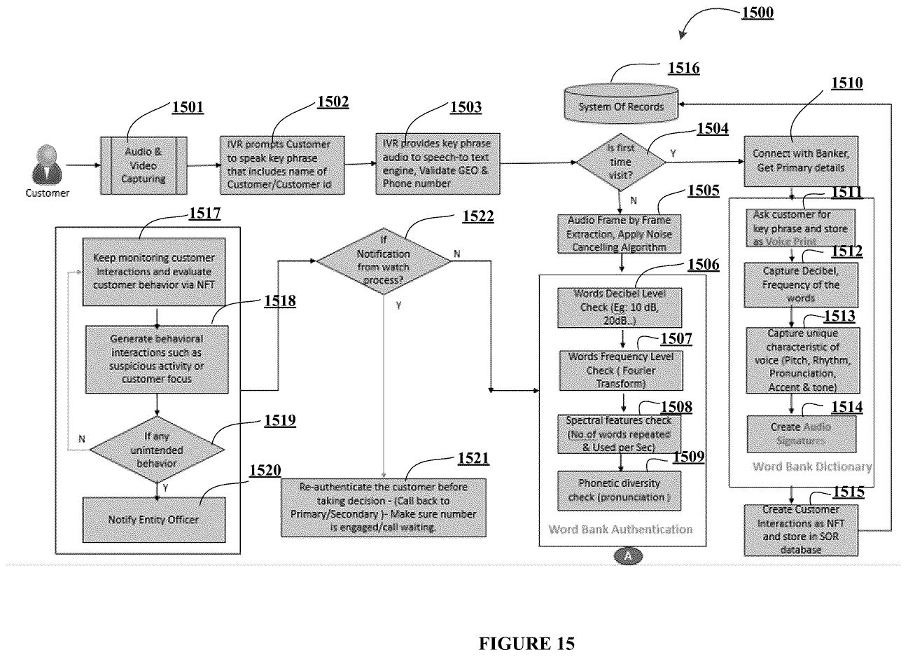

FIG. 15 illustrates an architecture flow 1500 for generating a word dictionary and identifying sound data from the multimedia input, in accordance with an embodiment of the disclosure. In some embodiments, a system (e.g., similar to one or more of the systems described herein with respect to FIGS. 1A-1C) may perform one or more of the steps of architecture flow 1500. For example, a system (e.g., the system 130 described herein with respect to FIG. 1A-1C) may perform the steps of architecture flow 1500. In some embodiments, an artificial intelligence model (e.g., such as the AI engine shown in FIG. 2) may perform some or all the steps described in architecture flow 1500.

As shown in architecture flow 1500, the process may start with the system receiving or capturing an audio and video multimedia input 1501 from a user associated with the system. Further, and in some embodiments, the system may use interactive voice response (IVR) system to generate and transmit a prompt to the user for the user to speak a key phrase, which includes a request for the user to input or state the name of the customer or customer ID (e.g., user identifier and/or authentication credentials) at block 1502. In some embodiments, and as shown in block 1503, the IVR prompt provides key phrase audio speech-to-text engine, which may additionally validate the location and the phone number of the user's user device before continuing to block 1504.

In some embodiments, and where the user of the multimedia input is determined to be a first time visitor for the system (as shown in block 1504), the system may connect the user with a user within an entity (e.g., a client of the system, such as a bank when the entity is a financial institution) to get the user's details, as shown in block 1510. Further, the system may additionally ask the user/customer for key phrase(s) and store the key phrase(s) and data as the voice print for the user, as shown in block 1511. Additionally, and as shown in block 1512, the system may capture decibel data, frequency data, and/or the like for the key phrases from the user. The system may additionally capture unique characteristic data of the user's voice (e.g., pitch, rhythm, pronunciation, accent, tone, and/or the like), as shown in block 1513, and this voice data may be used to generate the audio signature(s) for the user, as shown in block 1514. As shown in block 1515, the system may create user/customer interactions as a non-fungible token (NFT) on the distributed ledger and may store the data on a system of records at block 1500.

In some embodiments, and as shown in block 1517, the system may also keep monitoring customer/user interactions and evaluate the user behavior using the NFT stored for the user identifier. Further, and as shown in block 1518, the system may generate behavioral interactions such as any suspicious activity or customer/user focus, and based on these behavioral interactions, the system may use this information to determine whether a manager of the client's system should be notified for any suspicious behavior by the users in their interactions. As shown in block 1519, the system may determine whether any unintended or suspicious behavior has been identified. In an instance where suspicious behavior identified, a user within the client entity (e.g., an information technology (IT) user, a data security officer, and/or the like) may be notified automatically by the system.

In some embodiments, and as shown in block 1522, the system may determine if the notification to the client entity's user at block 1520 was for the interaction watch process of blocks 1517-1520. In an instance where the notification was from the interaction watch process, the system may re-authenticate the user/customer before making a decision on whether to block the user, call the user or call a secondary user for the user account, and/or the like, as shown in block 1521.

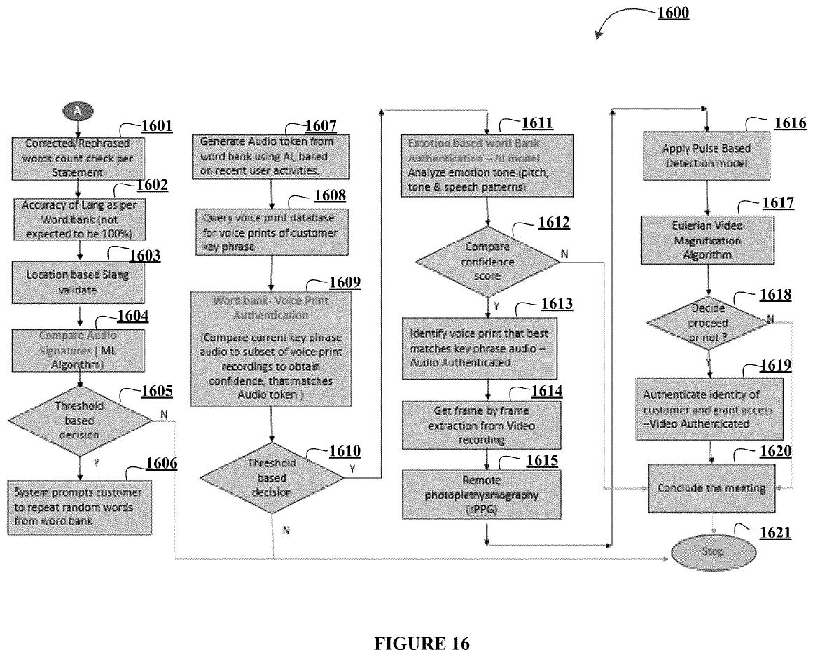

As shown in block 1504, the system may determine the user is not currently making a first time visit. As shown in block 1505, the system may extract the audio frame by frame, and apply a noise cancelling algorithm. In some such embodiments, the noise cancelling algorithm may perform a words decibel check, frequency check, spectral features check, phonetic diversity check, and/or the like, to reduce the noise within the multimedia input and/or key phrases. Further, and as shown in block 1506, the system may perform a word decibel check (e.g., 10 dB, 20 dB, and/or the like) over the entire word or within the syllables of each word (e.g., the decibels between syllables within a word may change according to speech patterns of the user). As shown in block 1507, the system may perform word frequency level checks, which may comprise a Fourier transform to determine the duration percentage for the words spoken by the user. For example, and where the word is “transaction,” the system may determine the duration percentage is 35% for “TRAN,” 20% for “sac,” and 45% for “TION.” In some embodiments, the system may additionally perform a spectral features check at block 1508, which may determine the number of words repeated by the user per second or over a shortened period of time. Such a determination for spectral features may comprise the determination whether repeating particular words, which allows the strengthens the system's ability to distinguish between different users based on the unique vocal characteristics of the user. As shown in block 1509, the system may perform a phonetic diversity check to determine the pronunciation of words by the user (e.g., location-based language, and/or the like). Additionally, the process shown herein may continue in FIG. 16.

FIG. 16 illustrates an architecture flow 1600 for determining whether the multimedia input is AI generated or non-AI generated based on one or more confidence scores and various processes, in accordance with an embodiment of the disclosure. In some embodiments, a system (e.g., similar to one or more of the systems described herein with respect to FIGS. 1A-1C) may perform one or more of the steps of architecture flow 1600. For example, a system (e.g., the system 130 described herein with respect to FIG. 1A-1C) may perform the steps of architecture flow 1600. In some embodiments, an artificial intelligence model (e.g., such as the AI engine shown in FIG. 2) may perform some or all the steps described in architecture flow 1600.

As shown in block 1601, the system may determine corrected/rephrased words count check per statement by the user. Thus, and in some embodiments, the system may identify which words are getting corrected or rephrased in the user's statements. By determining these corrected/rephrased words, the system may generate the confidence score. Additionally, and as shown in block 1602, the system may determine the accuracy of the user's language as compared to the word dictionary (which may not need to be 100% accurate). As shown in block 1603, the system may perform a location-based language validation for the user based on the word dictionary and the expected language-based language for the user. In some embodiments, the system may generate a current audio signature for the multimedia input, the current audio signature may be compared to the known audio signature from the word dictionary for the user account, as shown in block 1604.

In some embodiments, and as shown in block 1605, the system may make a confidence threshold based decision. In some embodiments, the system may determine the confidence score is below the confidence threshold, and thus the multimedia input is likely AI generated. In such an embodiment, the system may automatically block and/or stop the multimedia input, such as the step shown in block 1621. In some embodiments, and where the system determines the confidence score meets or exceeds the confidence threshold, the system may additionally prompt the user to repeat random words from the word dictionary to determine whether the multimedia input is AI generated.

In some embodiments, and as shown in block 1607, the system may generate an audio token using the word dictionary and the AI model, and based on historical/recent user activities and interactions. In some embodiments, and as shown in block 1608, the system may query a voice print database for voice prints of the key phrases associated with the user account. Further, and in some embodiments and as shown in block 1609, the system may generate the word dictionary with the voice print data for the user. In some such embodiments, the system may compare the current key phrase audio to the voice print recordings for the user to determine the confidence score that the current key phrase(s) match the audio token for the user.

In some embodiments, and as shown in block 1610, the system may determine whether the confidence score for the key phrases meet, exceed, or are less than the confidence threshold. In some embodiments, and as shown in block 1611, the system may determine that the confidence score meets or exceeds the confidence threshold, the system may determine the emotion features for the user by using the historical emotion features for the user (such as from the word dictionary) and the AI model to analyze the user's current emotion features (e.g., tone, pitch, speech patterns, and/or the like).

In some embodiments, the system may again compare a generated confidence score (such as from the emotion feature(s) of the user) to the confidence threshold, at block 1612. In some such embodiments, and upon the system determining the confidence score meets or exceeds the confidence threshold, the system may identify the voice print for the user that best matches the key phrase audio, as shown in block 1613. In some embodiments, the system may extract frame-by-frame images from the multimedia input, as shown in block 1614. In some embodiments, and as shown in block 1615, the system may perform remote photoplethysmography (rPPG) to determine the physical characteristics like cardiac rate or plasma oxygen saturation by determining subtle color variations to the user within the multimedia input. In some embodiments, the system may apply the frame-based detection model in block 1616 to determine the changes in physical characteristics to the user in the multimedia input, as shown in block 1616.

In some embodiments, and as shown in block 1617, the system may use a Eulerian video magnification algorithm to the frames in the multimedia input. Such a Eulerian video magnification algorithm may comprise an amplification of the user's physical characteristics and then scanning (and/or blurring) the frames from different axes perspectives to determine the periodic color variation to determine differences between the user's physical characteristics. In some such embodiments, and based on the physical characteristics determined the physical characteristics of the user, the system may decide whether to proceed with receiving the multimedia input and/or allowing an access request received from the user, as shown in block 1618. In some embodiments, and where the system determines not to continue, the system may conclude the meeting (e.g., as shown in block 1620) and block further interactions. In some embodiments, the system may authenticate the identity of the user/customer and grant access to the user within the multimedia input (i.e., determine the video is authenticated and non-AI generated).

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automatically identifying AI-generated audio and visual media, the system comprising:
a memory device with computer-readable program code stored thereon;
at least one processing device operatively coupled to the memory device and at least one communication device, wherein executing the computer-readable code is configured to cause the at least one processing device to:
receive a multimedia input from a user device;
receive a key phrase from the user device;
identify a user account based on the key phrase;
extract and parse each frame from the multimedia input, wherein each frame is parsed for sound data;
apply a word dictionary to at least one of the key phrase or each frame of the sound data, wherein the word dictionary is specific to the user account, and wherein the word dictionary is associated with an artificial intelligence (AI) model;
compare, by the AI model, the key phrase or each frame of sound data to the word dictionary, wherein each frame comprises at least one of word data, frequency data, decibel data, or phonetic data; and
determine, by the AI model, the multimedia input is AI-generated or non-AI generated based on the comparison of the key phrase or each frame of the sound to the word dictionary.

2. The system of claim 1, wherein each frame is further parsed for image data, wherein executing the computer-readable code is configured to cause the at least one processing device to:
apply each frame comprising the image data to a frame-based detection model, wherein the frame-based detection model is configured to apply spatial decomposition and temporal filtering to each frame of the image data;
determine, by the frame-based detection model, a signal of the multimedia input;
compare each frame corresponding with a location within the signal, wherein each location corresponds to a timestamp within the multimedia input; and
determine, based on the comparison, changes of low or high amplitude between each frame within the signal.

3. The system of claim 2, wherein a high amplitude corresponds to a determination the multimedia input is AI-generated.

4. The system of claim 1, in an instance where the multimedia input is determined as non-AI generated, wherein executing the computer-readable code is configured to cause the at least one processing device to:
identify at least one access request associated with the multimedia input, wherein the at least one access request is received in an instance before the multimedia input, in the multimedia input, or in the key phrase; and
allow the at least one access request by a user associated with the multimedia input.

5. The system of claim 1, wherein executing the computer-readable code is configured to cause the at least one processing device to:
generate, by the AI model and based on the word dictionary, an audio token associated with the user account, wherein the audio token is based on historical user data and word data;
compare, by the AI model, the key phrase or each frame of the sound data to the audio token; and
determine, based on the comparison of the key phrase or each frame of the sound data to the audio token, the multimedia input is AI-generated or non-AI generated.

6. The system of claim 1, wherein executing the computer-readable code is configured to cause the at least one processing device to:
generate, based on the comparison of the key phrase or each frame of the sound to the word dictionary, a confidence score, wherein the confidence score is an average score of similarities and differences between the key phrase or each frame of the sound data and the word dictionary over a period of the multimedia input;
compare the confidence score to a confidence threshold; and
determine the multimedia input is AI-generated or non-AI generated based on the comparison of the confidence score to the confidence threshold.

7. The system of claim 6, wherein the confidence score is generated based on a comparison of the key phrase or each frame of the sound to an audio token associated with the user account.

8. The system of claim 1, wherein executing the computer-readable code is configured to cause the at least one processing device to:
generate a prompt for a user associated with the multimedia input, wherein the prompt comprises a request for a specific word within the multimedia input;
transmit the prompt to the user device;
receive, in response to the transmission of the prompt, a response from the user device;
compare the response to the prompt; and
authenticate, based on the comparison of the response to the prompt, the user of the multimedia input as the user of the user account.

9. The system of claim 1, wherein executing the computer-readable code is configured to cause the at least one processing device to:
determine a current location of the user device;
access at least one preferred location of the user account;
compare the current location to the at least one preferred location; and
authenticate a user of the user device based on the current location matching the at least one preferred location.

10. The system of claim 1, wherein executing the computer-readable code is configured to cause the at least one processing device to:
determine a location-based language associated with the user account, wherein the location-based language comprises modified words;
compare the key phrase or each frame of the sound data to the location-based language; and
authenticate, based on the comparison of the key phrase or each frame of the sound data to the location-based language, a user of the user device is associated with the user account based on at least one match between the key phrase or each frame of the sound to the location-based language.

11. The system of claim 1, wherein executing the computer-readable code is configured to cause the at least one processing device to:
identify, by the AI model, a current emotion feature of the key phrase or the multimedia input, wherein the current emotion feature comprises at least one of a tone, a pitch, or a speech pattern;
determine, by the AI model, a normalized emotion feature of historical speech data for the user account;
compare the normalized emotion feature to the current emotion feature; and
authenticate a user of the user device based on the normalized emotion feature matching the current emotion feature.

12. The system of claim 1, wherein executing the computer-readable code is configured to cause the at least one processing device to:
identify, at a first instance, an identifier associated with the multimedia input or the key phrase;
compare the identifier to an authenticated identifier of the user account; and
authenticate a user of the user device based on the identifier matching the authenticated identifier.

13. The system of claim 12, wherein the identifier comprises a phone number, an account name, an IMEI number, or an address.

14. The system of claim 1, wherein executing the computer-readable code is configured to cause the at least one processing device to:
generate a distributed ledger for the user account;
collect historical communication data associated with the user account, wherein the historical communication data comprises historical multimedia inputs, historical sound data, or historical image data; and
update a node on the distributed ledger at each instance historical communication data is collected.

15. The system of claim 1, wherein executing the computer-readable code is configured to cause the at least one processing device to:
detect a change in the multimedia input, wherein the change is related to a user in an image of the multimedia input, a sound in the multimedia input, an identifier change, or a geolocation change; and
automatically block the multimedia input in an instance where the change is detected.

16. A computer program product for automatically identifying AI-generated audio and visual media, wherein the computer program product comprises at least one non-transitory computer-readable medium having computer-readable program code portions embodied therein, the computer-readable program code portions which when executed by a processing device are configured to cause the processor to:
receive a multimedia input from a user device;
receive a key phrase from the user device;
identify a user account based on the key phrase;
extract and parse each frame from the multimedia input, wherein each frame is parsed for sound data;
apply a word dictionary to at least one of the key phrase or each frame of the sound data, wherein the word dictionary is specific to the user account, and wherein the word dictionary is associated with an artificial intelligence (AI) model;
compare, by the AI model, the key phrase or each frame of sound data to the word dictionary, wherein each frame comprises at least one of word data, frequency data, decibel data, or phonetic data; and
determine, by the AI model, the multimedia input is AI-generated or non-AI generated based on the comparison of the key phrase or each frame of the sound to the word dictionary.

17. The computer program product of claim 16, wherein the computer-readable program code portions which when executed by the processing device are configured to cause the processor to:
apply each frame comprising the image data to a frame-based detection model, wherein the frame-based detection model is configured to apply spatial decomposition and temporal filtering to each frame of the image data;
determine, by the frame-based detection model, a signal of the multimedia input;
compare each frame corresponding with a location within the signal, wherein each location corresponds to a timestamp within the multimedia input; and
determine, based on the comparison, changes of low or high amplitude between each frame within the signal.

18. The computer program product of claim 16, wherein the computer-readable program code portions which when executed by the processing device are configured to cause the processor to:
generate, by the AI model and based on the word dictionary, an audio token associated with the user account, wherein the audio token is based on historical user data and word data;
compare, by the AI model, the key phrase or each frame of the sound data to the audio token; and
determine, based on the comparison of the key phrase or each frame of the sound data to the audio token, the multimedia input is AI-generated or non-AI generated.

19. A computer implemented method for automatically identifying AI-generated audio and visual media, the computer implemented method comprising:
receiving a multimedia input from a user device;
receiving a key phrase from the user device;
identifying a user account based on the key phrase;
extracting and parsing each frame from the multimedia input, wherein each frame is parsed for sound data;
applying a word dictionary to at least one of the key phrase or each frame of the sound data, wherein the word dictionary is specific to the user account, and wherein the word dictionary is associated with an artificial intelligence (AI) model;
comparing, by the AI model, the key phrase or each frame of sound data to the word dictionary, wherein each frame comprises at least one of word data, frequency data, decibel data, or phonetic data; and
determining, by the AI model, the multimedia input is AI-generated or non-AI generated based on the comparison of the key phrase or each frame of the sound to the word dictionary.

20. The computer implemented method of claim 19, further comprising:
applying each frame comprising the image data to a frame-based detection model, wherein the frame-based detection model is configured to apply spatial decomposition and temporal filtering to each frame of the image data;
determining, by the frame-based detection model, a signal of the multimedia input;
comparing each frame corresponding with a location within the signal, wherein each location corresponds to a timestamp within the multimedia input; and
determining, based on the comparison, changes of low or high amplitude between each frame within the signal.
